(19) United States
(12) Patent Application Publication
(10) Pub. No.: US 2023/0144265 A1
(43) Pub. Date: May 11, 2023

(54) MAGNETIC TOOL AND CLEANING METHOD

(71) Applicant: Lone Star Magnetics, LLC, Sherman, TX (US)

(72) Inventor: Robert W. Bennett, Sherman, TX (US)

(21) Appl. No.: 17/976,983

(22) Filed: Oct. 31, 2022

Related U.S. Application Data
(60) Provisional application No. 63/276,693, filed on Nov. 8, 2021.

(51) Int. Cl. B03C 1/28; E21B 21/06; E21B 31/06

(52) U.S. Cl. CPC B03C 1/286; E21B 21/065; E21B 31/06; B03C 2201/18

(57) ABSTRACT

A magnetic tool may be provided with a ditch magnet that may include end plates (or handles) having a mostly open architecture, and these end plates may be permanently affixed to the ends of the magnetic bar. Ferrous metal may pass through by urging captured ferrous metal from one end of the ditch magnet to the opposite end. The captured ferrous metal may be urged from one end of the ditch magnet bar to an opposite end using a composite, multi-component wiper. The wiper may remove captured ferrous metal safely and effectively from the ditch magnet bar.

### CROSS-REFERENCE TO RELATED APPLICATION

The present Application is a non-provisional of, and claims priority to, U.S. Patent Application No. 63/276,693 filed Nov. 8, 2021, the disclosure of which is incorporated by reference in its entirety.

### FIELD OF THE DISCLOSURE

The present disclosure generally relates to ditch magnets, and more particularly to magnetic assemblies used to remove ferrous metals from an oilfield drilling mud stream.

### BACKGROUND

A Halbach magnetic circuit or array provides increased attracting and holding power over conventional magnetic circuits. The Halbach array effectively increases the magnetic surface gauss which, in turn, holds more ferrous metal, especially the lower mass, fine ferrous metal particulate. It is highly important to capture ferrous metal in the drilling mud stream, especially fine metal, since the drilling mud is recycled down the wellbore and the shale shaker screens may permit the fine metal to pass through if the fine metal is smaller than the screen aperture.

### SUMMARY

Embodiments of the present disclosure may provide a magnetic tool with a ditch magnet that may include end plates (or handles) having a mostly open architecture. These end plates may be permanently affixed to the ends of the magnetic bar. Ferrous metal may pass through by urging captured ferrous metal from one end of the ditch magnet to the opposite end. The captured ferrous metal may be urged from one end of the ditch magnet bar to an opposite end using a composite, multi-component wiper. The wiper may remove captured ferrous metal safely and effectively from the ditch magnet bar.

Embodiments of the present disclosure may provide a magnetic tool comprising: at least one magnetic bar; and end plates affixed to each end of the at least one magnetic bar, the at least one magnetic bar and the end plates forming a ditch magnet, wherein captured ferrous metal may be urged through from one end of the ditch magnet to an opposite end. The end plates may be permanently affixed to each end of the at least one magnetic bar. The end plates may be located inboard on each end of the at least one magnetic bar. The magnetic tool also may include a composite, multi-component wiper that may urge the captured ferrous metal from one end of the ditch magnet to the opposite end. The wiper may remove the captured ferrous metal from the at least one magnetic bar. The wiper may be applied to each of the at least one magnetic bar. The wiper may include two or more components that are capable of being installed, removed, and replaced without removing the end plates when they are affixed to the at least one magnetic bar. The ditch magnet may be used in an oilfield drilling fluid mud stream.

Other embodiments of the present disclosure may provide a magnetic tool comprising at least one magnetic bar; end plates affixed to each end of the at least one magnetic bar, the at least one magnetic bar and the end plates forming a ditch magnet; and a take-apart wiper comprising two or more components that are capable of being installed, removed, and replaced without removing the end plates when they are affixed to the at least one magnetic bar, wherein the take-apart wiper may urge captured ferrous metal through from one end of the ditch magnet to an opposite end. The take-apart wiper may be formed of a non-ferrous material. The take-apart wiper may further include one or more fasteners. The one or more fasteners may be nylon-insert flange locknuts that firmly grip threads to resist loosening and distribute load. The end plates may be permanently affixed to the at least one magnetic bar. The end plates may have an open architecture capable of allowing the captured ferrous metal to pass through without releasing the end plates from the at least one magnetic bar. The at least one magnetic bar may include two or more magnets affixed to a low-carbon steel pole, wherein the two or more magnets affixed to the pole are installed in a stainless-steel tube. The at least one magnetic bar may include spacers positioned between the two or more magnets when affixed to the pole. The end plates may have an outside diameter that is greater than the take-apart wiper interior diameter.

Further embodiments of the present disclosure may provide a method for using a magnetic tool comprising: collecting ferrous metal on a magnetic bar having a first end plate on a first end and a second end plate on a second end with a wiper secured beneath the first end plate, the collecting step comprising: turning the magnetic bar in a vertical direction; and moving the wiper from its position beneath the first end plate down toward the second end plate, wherein ferrous metal releases from the magnetic bar moving through the second end plate to form piles of captured ferrous metal. The magnetic tool may be placed in an oilfield drilling fluid mud recycling stream having ferrous metal from the wellbore to attract and retain the ferrous metal to prevent the ferrous metal from being reintroduced into the wellbore. The method also may include removing the magnetic tool from the oilfield drilling fluid mud recycling stream for cleaning; and removing the captured ferrous metal from the magnetic bar.

### BRIEF DESCRIPTION OF THE DRAWINGS

For a more complete understanding of this disclosure, reference is now made to the following description, taken in conjunction with the accompanying drawings, in which:

FIG. 1 depicts a magnetic tool according to an embodiment of the present disclosure;

FIG. 2A depicts an exploded view of a magnetic bar of a magnetic tool according to an embodiment of the present disclosure;

FIG. 2B depicts a configuration of raw magnets within the magnetic bar according to an embodiment of the present disclosure;

FIG. 2C depicts another view of a magnetic bar of the magnetic tool according to an embodiment of the present disclosure;

FIG. 3 depicts an end plate (handle) according to an embodiment of the present disclosure;

FIG. 4A depicts a take-apart wiper design according to an embodiment of the present disclosure;

FIG. 4B depicts a spool style take-apart wiper design according to an embodiment of the present disclosure;

FIGS. 4C and 4D depict views of a take-apart wiper according to an embodiment of the present disclosure; and

FIG. 5 depicts a flow chart of use of a magnetic tool according to an embodiment of the present disclosure.

### DETAILED DESCRIPTION

Embodiments of the present disclosure may provide a magnetic tool that may incorporate one or more Halbach magnetic circuits in a permanent magnetic assembly, resulting in improved magnetic attraction and holding power. The one or more Halbach magnetic circuits being used in a permanent magnetic assembly may be referred to as a ditch magnet. The magnetic assembly may be used in an oilfield drilling fluid “mud” stream in embodiments of the present disclosure.

The ditch magnet may include end plates (or handles) having a mostly open architecture, and these end plates may be permanently affixed to the ends of the magnetic bar. Ferrous metal may pass through by urging captured ferrous metal from one end of the ditch magnet to the opposite end. The captured ferrous metal may be urged from one end of the ditch magnet bar to an opposite end using a composite, multi-component wiper. The wiper according to embodiments of the present disclosure may remove captured ferrous metal safely and effectively from the ditch magnet bar. It should be appreciated that the wiper may be used with a ditch magnet bar where the end plates (handles) are either permanently attached or located inboard of the ditch magnet bar ends.

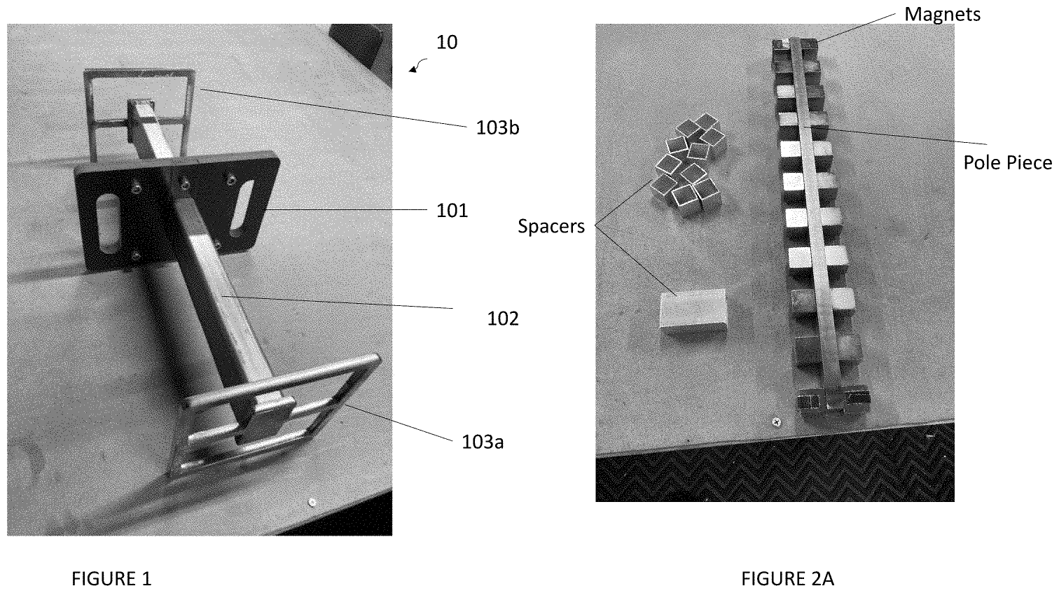

FIG. 1 depicts magnetic tool 10 according to an embodiment of the present disclosure. Magnetic tool 10 may include magnetic bar 102 including take-apart wiper 101 with end plates (handles) 103a, 103b attached to each end of magnetic bar 102. While a single magnetic bar 102 is depicted herein, it should be appreciated that magnetic tool 10 may include two or more magnetic bars as described in more detail herein. Wiper 101 may be applied to each of the magnetic bars.

Wiper 101 may be formed of a non-ferrous material and may comprise two or more components that may be installed, removed, and replaced without removing end plates 103a, 103b from where they are affixed to magnetic bar 102. In embodiments of the present disclosure, wiper 101 may include fasteners, including, but not limited to, 18-8 stainless steel nylon-insert flange locknuts and/or 18-8 stainless steel socket head screws. Inclusion of a nylon insert may firmly grip threads to resist loosening, and the flange may distribute load over a large area. However, other fasteners may be utilized in wiper 101 without departing from the present disclosure. Further, while fasteners have been described as formed of stainless steel, other materials may be used without departing from the present disclosure.

End plates (handles) 103a, 103b may be permanently affixed to magnetic bar 102 without fasteners or bolts needed to removably secure end plates 103a, 103b to magnetic bar 102. The open architecture of end plates 103a, 103b may allow ferrous metal to pass through without removing fasteners or bolts to release end plates 103a, 103b from magnetic bar 102, thereby saving time and reducing the likelihood of misplacing or losing components of magnetic tool 10.

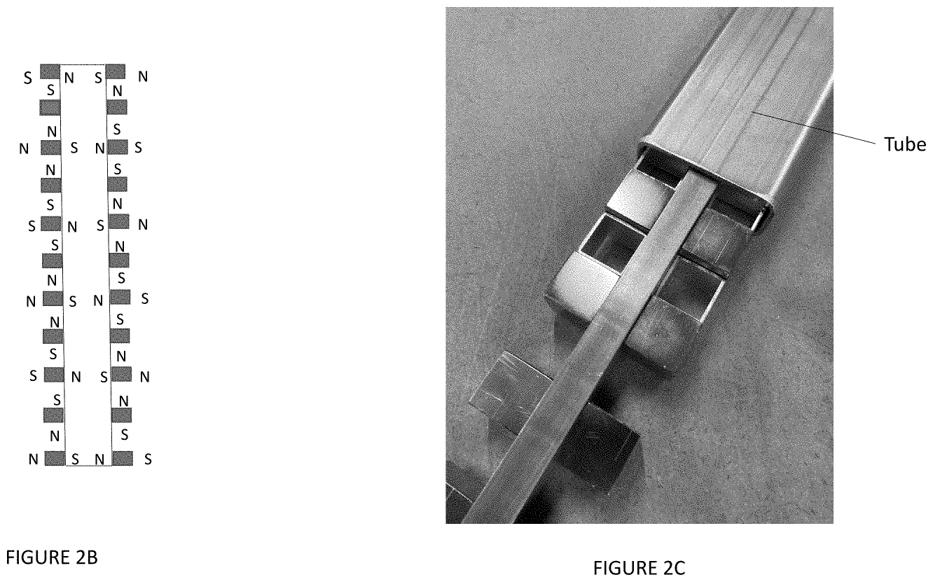

FIG. 2A depicts an exploded view of a magnetic bar of a magnetic tool according to an embodiment of the present disclosure. More specifically, magnetic bar 102 of FIG. 1 may be formed of two or more magnets affixed to a mild steel pole piece as depicted in FIG. 2A. FIG. 2B depicts a configuration of raw magnets within the magnetic bar according to an embodiment of the present disclosure. Aluminum spacers may be positioned between the magnets when they are attached to the pole piece. While aluminum spacers are described herein, it should be appreciated that other materials may be used to form the spacers without departing from the present disclosure. In an embodiment of the present disclosure, raw magnets may be utilized to cover a length of 24 inches with 1 inch of space between each of the raw magnets that may be 1 inch in length. However, it should be appreciated that the length may vary as may the space between the raw magnets without departing from the present disclosure. There also may be embodiments of the present disclosure where the raw magnets may touch each other. The pole piece may be formed of a low-carbon (mild) steel bar in an embodiment of the present disclosure. However, it should be appreciated that other materials may be used for forming the pole piece without departing from the present disclosure.

FIG. 2C depicts another view of the magnetic bar of the magnetic tool according to an embodiment of the present disclosure. As depicted herein, once the raw magnets have been attached to the pole piece and the spacers have been placed, the raw magnets, pole piece, and the spacers may be installed in a stainless-steel tube in an embodiment of the present disclosure. The tube may be a multipurpose 304 stainless steel rectangular tube in an embodiment of the present disclosure. However, while the tube is described as formed of stainless steel, it should be appreciated that other materials may be used without departing from the present disclosure. Further, it should be appreciated that the tube may be a shape other than rectangular without departing from the present disclosure.

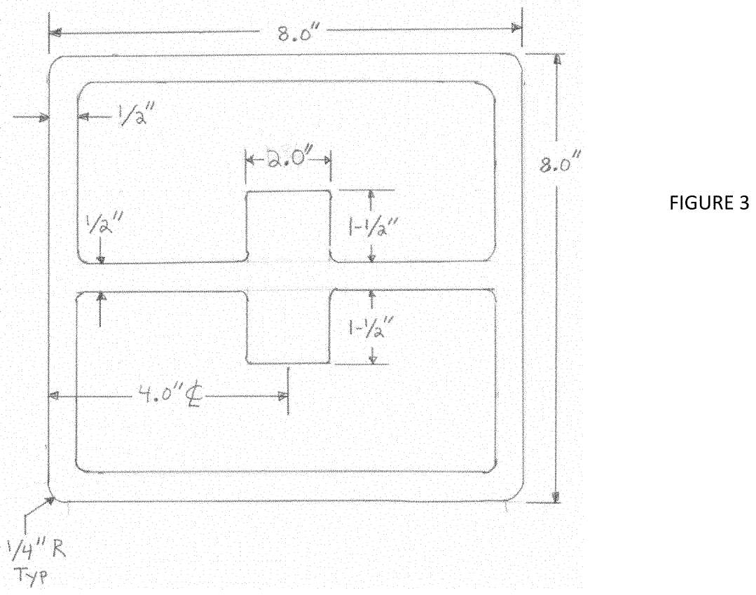

FIG. 3 depicts an end plate (handle) according to an embodiment of the present disclosure. Each end plate may be formed of multipurpose 304 stainless steel in an embodiment of the present disclosure; however, other materials may be used without departing from the present disclosure. While FIG. 3 depicts dimensions of an end plate, it should be appreciated that the dimensions may be scaled up or down without departing from the present disclosure.

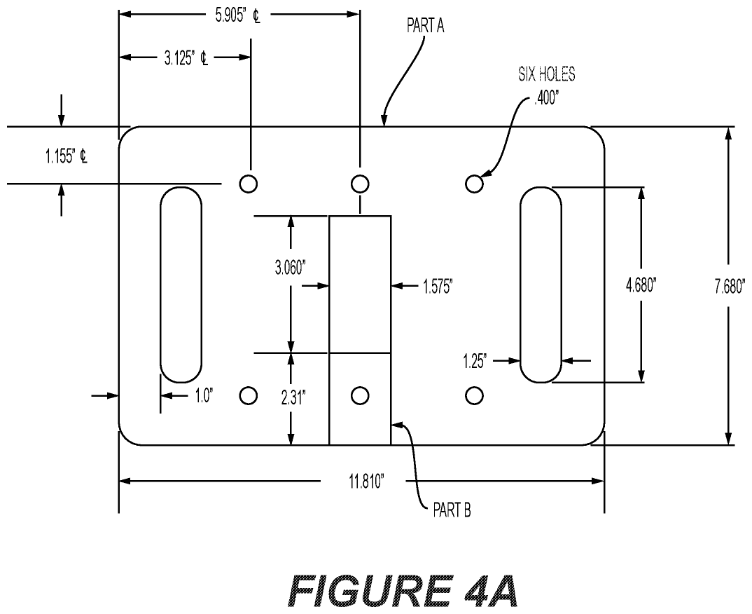

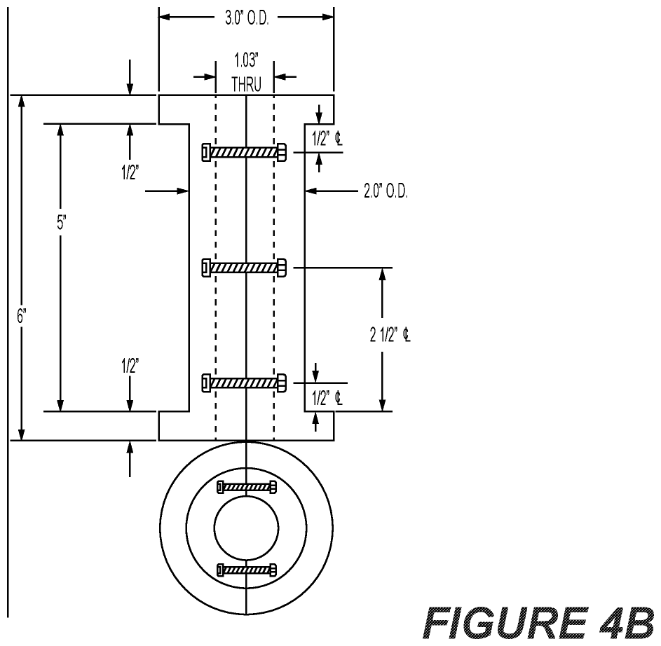

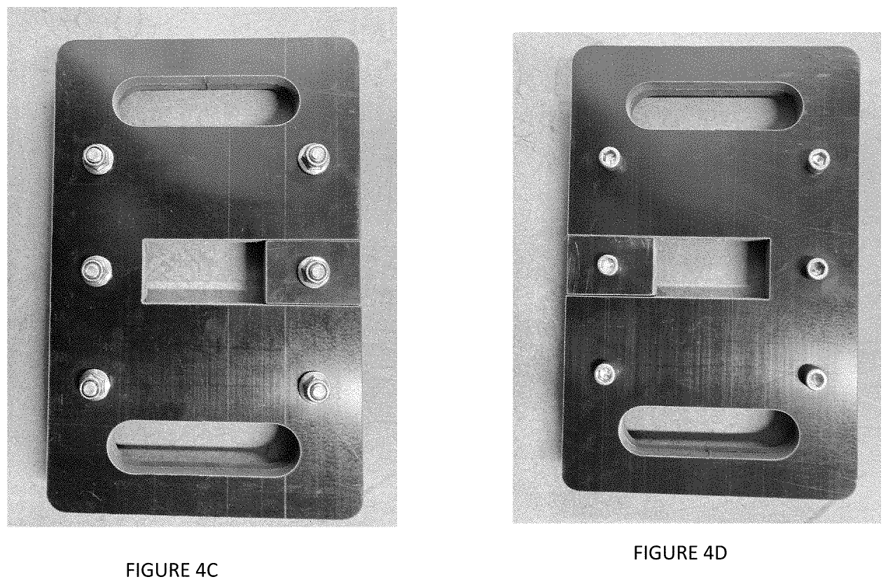

FIG. 4A depicts a take-apart wiper design according to an embodiment of the present disclosure. FIG. 4B depicts a spool style take-apart wiper design according to an embodiment of the present disclosure. Wipers as depicted in FIGS. 4A and 4B may be installed, removed, and replaced on a magnetic bar, and the wiper may include two or more components mechanically attached to each other. The wiper of FIG. 4A is depicted as including Part A and Part B, and it should be appreciated that two of Part A and two of Part B may be utilized in a magnetic tool according to an embodiment of the present disclosure. It should be appreciated that the interior diameter of the wiper may encompass the outside diameter of the magnetic bar in an embodiment of the present disclosure. The end plates, such as depicted in FIG. 3, may have an outside diameter that is greater than the wiper interior diameter. While FIGS. 4A and 4B depict dimensions of a wiper, it should be appreciated that the dimensions may be scaled up or down without departing from the present disclosure. FIGS. 4C and 4D depict views of a take-apart wiper according to an embodiment of the present disclosure.

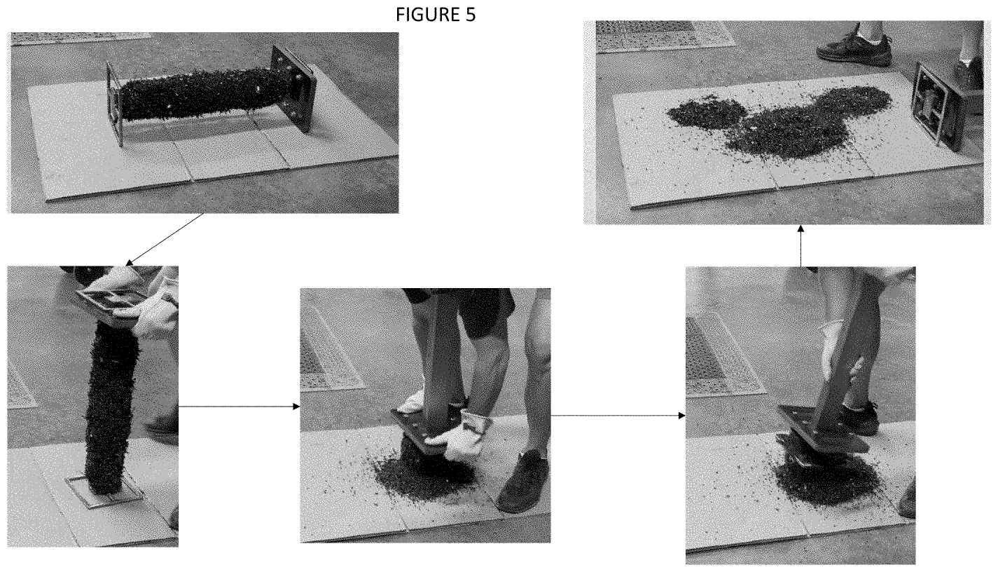

FIG. 5 depicts a flow chart of use of a magnetic tool according to an embodiment of the present disclosure. As depicted herein, ferrous metal may be collected on the magnetic bar between the end plates. The magnetic tool may be turned in a vertical direction with the user gripping one end of the magnetic tool at the first end plate where the wiper has been secured beneath the end plate. The user may place his/her hands on the wiper and move the wiper from its position just beneath the first end plate down toward the second end plate. As the user moves the wiper, ferrous metal may release from the magnetic bar, moving through the open architecture of the second end handle to form piles of ferrous metal apart (separated) from the magnetic tool.

In operation, as depicted, for example, in FIG. 5, the magnetic tool may be placed in an oilfield drilling fluid “mud” recycling stream. The drilling mud contains ferromagnetic particulate from the wellbore. The magnetic tool may attract and retain the ferromagnetic particulate to prevent the ferrous metal from being reintroduced in the wellbore. Drilling mud is very expensive and is typically recycled. The magnetic tool may be removed from the drilling mud stream for the purpose of cleaning, and the captured ferrous metal may be removed from the magnetic bar. The ferrous metal may be urged from one end of the magnetic bar to the opposite end with the wiper which may push the ferrous metal through the open architecture end plate via human hands.

While embodiments of the present disclosure have been described for use in an oilfield drilling fluid “mud” recycling stream, it should be appreciated that the magnetic tool may be used in other liquid flow processes or in dry flow processes such as the food industry and the plastics industry without departing from the present disclosure. It also should be appreciated that the magnetic tool according to embodiments of the present disclosure may be suspended above a process flow stream, such as in an installation over a conveyor belt or vibratory conveyor.

It should be appreciated that there may be embodiments of the present disclosure where the magnetic tool may be used without inclusion of a mechanical wiper. There also may be embodiments of the present disclosure where a wiper may be used on a magnetic bar of a magnetic tool where the magnetic circuit does not include one or more Halbach magnetic circuits.

The magnetic tool according to embodiments of the present disclosure may improve ferrous metal capture and cleaning. As magnet strength within the magnetic tool increases, more ferrous metal may be captured, and use of the wiper allows for easier removal of the captured ferrous metal. In addition, use of the magnetic tool according to embodiments of the present disclosure may provide a safer means for removal of ferrous metal, as ferrous metal can be sharp and cause injury to a user. Inclusion of the wiper in the magnetic tool according to embodiments of the present disclosure may reduce these safety hazards involved in cleaning off the ferrous metal, along with decreasing the amount of time to perform the cleaning cycle. This may allow the ditch magnet to be more quickly placed back in service.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A magnetic tool comprising:
at least one magnetic bar; and
end plates affixed to each end of the at least one magnetic bar, the at least one magnetic bar and the end plates forming a ditch magnet,
wherein captured ferrous metal is urged through from one end of the ditch magnet to an opposite end.

2. The magnetic tool of claim 1, wherein the end plates are permanently affixed to each end of the at least one magnetic bar.

3. The magnetic tool of claim 1, wherein the end plates are located inboard on each end of the at least one magnetic bar.

4. The magnetic tool of claim 1 further comprising:
a composite, multi-component wiper that urges the captured ferrous metal from one end of the ditch magnet to the opposite end.

5. The magnetic tool of claim 4, wherein the wiper removes the captured ferrous metal from the at least one magnetic bar.

6. The magnetic tool of claim 4, wherein the wiper is applied to each of the at least one magnetic bar.

7. The magnetic tool of claim 4, wherein the wiper comprises two or more components that are capable of being installed, removed, and replaced without removing the end plates when they are affixed to the at least one magnetic bar.

8. The magnetic tool of claim 1, wherein the ditch magnet is used in an oilfield drilling fluid mud stream.

9. A magnetic tool comprising:
at least one magnetic bar;
end plates affixed to each end of the at least one magnetic bar, the at least one magnetic bar and the end plates forming a ditch magnet; and
a take-apart wiper comprising two or more components that are capable of being installed, removed, and replaced without removing the end plates when they are affixed to the at least one magnetic bar,
wherein the take-apart wiper urges captured ferrous metal through from one end of the ditch magnet to an opposite end.

10. The magnetic tool of claim 9, wherein the take-apart wiper is formed of a non-ferrous material.

11. The magnetic tool of claim 9, where the take-apart wiper further includes one or more fasteners.

12. The magnetic tool of claim 11, the one or more fasteners comprising:
nylon-insert flange locknuts that firmly grip threads to resist loosening and distribute load.

13. The magnetic tool of claim 9, wherein the end plates are permanently affixed to the at least one magnetic bar.

14. The magnetic tool of claim 9, the end plates having an open architecture capable of allowing the captured ferrous metal to pass through without releasing the end plates from the at least one magnetic bar.

15. The magnetic tool of claim 9, the at least one magnetic bar comprising:
two or more magnets affixed to a low-carbon steel pole, wherein the two or more magnets affixed to the pole are installed in a stainless-steel tube.

16. The magnetic tool of claim 15, the at least one magnetic bar further comprising:
spacers positioned between the two or more magnets when affixed to the pole.

17. The magnetic tool of claim 9, wherein the end plates have an outside diameter that is greater than the take-apart wiper interior diameter.

18. A method for using a magnetic tool comprising:
collecting ferrous metal on a magnetic bar having a first end plate on a first end and a second end plate on a second end with a wiper secured beneath the first end plate, the collecting step comprising:
turning the magnetic bar in a vertical direction; and
moving the wiper from its position beneath the first end plate down toward the second end plate, wherein ferrous metal releases from the magnetic bar moving through the second end plate to form piles of captured ferrous metal.

19. The method of claim 18, wherein the magnetic tool is placed in an oilfield drilling fluid mud recycling stream having ferrous metal from the wellbore to attract and retain the ferrous metal to prevent the ferrous metal from being reintroduced into the wellbore.

20. The method of claim 19 further comprising:
removing the magnetic tool from the oilfield drilling fluid mud recycling stream for cleaning; and
removing the captured ferrous metal from the magnetic bar.
